(19) United States
(12) Patent Application Publication
(10) Pub. No.: US 2018/0158557 A1
(43) Pub. Date: Jun. 7, 2018

(54) Device for Cleaning the Cover Flange of the Reactor Vessel in a Nuclear Plant

(71) Applicant: Ingenieria Y Marketing, S.A., Valencia (ES)

(72) Inventor: Jesús Lacalle Bayo, Valencia (ES)

(73) Assignee: Ingenieria Y Marketing, S.A., Valencia (ES)

(21) Appl. No.: 15/568,612

(22) PCT Filed: Apr. 30, 2015
(86) PCT No.: PCT/ES2015/070358

§ 371 Date: Oct. 23, 2017

(51) Int. Cl. G21F 9/00; G21C 13/02; B08B 1/00; B08B 1/04

(52) U.S. Cl. CPC G21F 9/00; G21C 13/02; G21Y 2004/502; B08B 1/04; G21Y 2002/40; B08B 1/006

(57) ABSTRACT

A device for cleaning the cover flange of the reactor vessel in a nuclear plant includes a pull arrangement for moving the device in translation along the perimeter of the flange, and an arrangement for removing dirt from the flange, the device being formed mainly by: a central body provided with a dirt removal device, the central body including an outer casing having a front support and a rear support attached thereto; a front wheel assembly supporting a front wheel support; a rear wheel assembly supporting a rear wheel support; a device for adjusting the angular position of the front wheel support in relation to the central body; and a device for adjusting the angular position of the rear wheel support in relation to the central body, and the central body is provided with a floating inner body.

This invention consists of an apparatus for cleaning the flange or perimeter surface on which the cover of the vessel containing the fuel of a thermoelectric nuclear power station rests. This apparatus is operated by remote control, in a submerged environment, and comprises a set of cleaning rollers, a drive assembly provided with one or more positioning probes in respect of the edge of the flange and a suction assembly fitted with a filter for collecting particles in which the drive assembly has means for adjustment in different angular positions for cleaning flanges of different diameters, and the probes are in turn adjustable in respect of the distance from the apparatus to the edge of the flange.

The sealing of the cover of a nuclear reactor at a thermoelectric nuclear power plant is well known to be of vital importance for the safety of the power plant. There are one or more annular channels in the cover on which the corresponding O-ring seals are placed, these normally being made of a relatively soft metal material, such as silver, silver alloys or alloys of other metals. Deposits and incrustations, normally debris from the aforementioned joint, are formed on the flange on which the cover rests, and particularly the joint seal. These deposits could jeopardise the sealing of the vessel and this flange thus has to be left in optimum condition. Although the deposits which might be left during the power plant's operation do not affect the sealing, when the cover is lifted and then fitted again these deposits can indeed affect the sealing if they are not properly removed.

This cleaning operation must therefore be carried out every time the cover of the reactor vessel is lifted, that is, during maintenance operations, and particularly during the operations for reloading fuel.

### STATE OF THE ART

The flange has traditionally been cleaned manually. The personnel performing said cleaning operation is nevertheless exposed to doses of ionising radiation and although said dose is monitored and the operator is protected by suitable protective clothing, exposure periods are limited, there being an unnecessary risk for the person in any event.

U.S. Pat. No. 5,346,584 describes a device for polishing the support base for a cover, such as the flange of the vessel of a reactor at a nuclear power plant, particularly conceived for running along an annular track surrounding the flange. A triangular frame is provided, resting on three angularly equidistant points of the flange, reducing its radial displacement. This is provided with polishing disks at the bottom, and it has wheels for moving along said annular track. This device involves different problems; first of all it is conceived for specific dimensions and geometry of the vessel flange, it has a tendency to undergo radial displacement along the route and although it has a probe, this is placed at a certain distance from the polishing device, which limits or prevents its use in certain types of flanges, diameters, etc.

Firms Westinghouse, Remote Ocean Systems and Texas Utilities developed a device for cleaning the flange of the cover of the vessel of a nuclear power plant which the first of these calls FlangeBot, in which there is a set of drive wheels with cleaning and drying devices. The device is self-propelled, with no cables, and radio-controlled. It has a cleaning roller and an absorbing roller, which can also be pulled along by the device. Like the device mentioned above, it does not however satisfactorily solve the matter of radial deviation from its course nor guarantee the position of the track in respect of the edge on which the cleaning operation is to be carried out, since it will depend on the operator's skill and the precision of the manoeuvre. What is more, because it does not remove the dirt, but places this on a roller, some particles may come off and be left on the section already covered.

At http://www.rovtech.com/Cleaning/Index.html one can also see a device for cleaning the surface of the flange of the reactor vessel of a thermoelectric nuclear power plant, which uses rotary cleaning pads. This is constructed as an arch to form the curve of the edge, with the pads at the ends and the drive system in the centre. To change the rotation radius the four supports of the pads have to be replaced; it has no evacuation system nor allows a variable distance from the edge to the cleaning surface.

None of these antecedents is however adaptable to a variable flange diameter without replacing some part, nor is able to be adjusted so that the distance from the cleaning track to the edge of the flange is easily and effectively adjustable on a variable basis; it is furthermore desirable for the debris dislodged to be removed, which is done in this invention by means of a suction pump enabling the removal of said products from the surface and preventing them from being deposited again, while the cleaning is done by means of cleaning rollers which remove, but do not store, the dirt.

Furthermore, in the precursors it has been observed that the non-existence of any angular adjustment of the drive system causes a tendency to displace the head (the front zone) generally towards the inner edge of the flange, which means that the cleaning position is displaced in respect of the one desired and there is also a risk of falling into the vessel.

It is furthermore considered necessary to ensure not only the dislodging of the particles or debris from the flange, but also their effective removal, to prevent them from falling into the cavity of the vessel or from being deposited on the cleaned surface again after being dislodged.

### DESCRIPTION OF THE INVENTION

This invention refers to a cleaning apparatus for the sealing flange of the vessel of the reactor at a nuclear plant which is mainly made up of:
a central body, which constitutes a casing closed at its sides and at its top, which houses an inner body with at least one and preferably a pair of cleaning rollers;
a device for suction and evacuation of the dirt dislodged by the rollers;
the suction device consists of a suction bell placed between the cleaning rollers, a suction pump and a filter placed at the outlet of the suction pump; the outlet from the filter has been placed laterally towards the rotation centre in order to prevent any interference with the guide bolts on the cover and with the electricity supply and movement and control wires;
A articulated support for a front train and a articulated support for the rear train, in which at least one of said front and/or rear trains is provided with a drive system;
A means for adjusting the angular position of the articulated support of the front train in respect of the central body;
A means for adjusting the angular position of the articulated support of the rear train in respect of the central body;
A lateral probe placed in the train which determines the distance from the cleaning track to the inner edge of the flange;
Means for adjusting the distance from the front and rear lateral probes in respect of the respective front and rear trains.

As was already stated above, the cleaning apparatus of this invention is made up of a central body, which houses the cleaning elements. In particular, this central body is made up of an outer casing and an inner body; the inner body is placed in a floating arrangement in the outer casing, and can be provided with joining means, such as guide-slots or guide rods, enabling vertical displacement between the casing and the inner body but which keep them connected; where applicable this may also comprise springs for adjusting the tension between said inner body and said casing, determining the force which said cleaning rollers apply.

The wear caused to the cleaning items, particularly to the rollers, in the event of said rollers being located at a fixed height in respect of the support structure, as is the case of all the background inventions described, results in a reduction or loss of contact between the cleaning item and the surface to be cleaned. The solution proposed in this invention means that it is the weight of the inner body which exerts the pressure of the rollers on the surface to be cleaned, whatever the state of wear of said rollers, said pressure being where required corrected by springs or other holding and regulating items. The inner body thus comprises a floating chassis which will hold the cleaning rollers, and normally also means for driving said rollers (motors, transmissions, etc.), and the suction items (bell, pump, filter). This means that the pressure applied by the rollers on the surface will always be regular, regardless of the state of wear of the cleaning surface or of the deformations in said surface, in this case of the rollers.

The casing of the central body will comprise one or more lugs for lifelines and/or for extraction from the pool in which the flange is located by means of a crane.

The central body is fitted with front and rear supports. These supports are provided with a housing for a rotary element such as a bearing. The rotary element holds a wheel support, said wheel support being capable of angular adjustment in respect of the corresponding front and rear support on which this is held. To this end the wheel supports are provided with devices for adjusting the annular position in respect of the respective front and rear supports. More specifically, these adjustment devices are formed of a pair of screws which act against a respective stop; when the screws are retracted (not meeting the stop), the wheel support may turn in respect of the corresponding front or rear support up to the position in which the end of one of the screws makes contact with the corresponding stop; in the required position the screws are adjusted so that this prevents rotation in one direction and the opposite one (each of the screws in the wheel support will limit one rotation direction against the corresponding stop on the front or rear support), for which reason the wheel support will be placed at a certain angle in respect of said front or rear supports. The front and/or rear supports hold respective motors, which by means of a transmission system transfers the rotation movement to the wheels. According to a specific embodiment, the wheels constitute a continuous roller divided into two parts, in which the transmission elements for the movement are arranged between said two parts.

Each of the front and rear wheel supports has a corresponding probe on one of its sides. The probe consists of a freely rotating wheel, which will be placed on the vessel, resting on the inner edge of the flange. This probe is located on a probe support, provided with a slot in which said probe is held in the required position.

The devices for regulating the angular position of the wheel supports and of the distance (position) at which the probe is located may be provided with graduated scales for absolute accuracy.

As regards the cleaning device, as was already stated, this is located in the inner body of the central body and consists of a set of cleaning rollers, normally two, which rotate in opposite directions driven by respective motors, wiping the dirt off the surface towards a suction bell arranged between said cleaning rollers; the rollers are placed with an axis perpendicular to the movement direction of the apparatus. The axles of the rollers are easily removable from the respective rollers.

According to a preferential embodiment, the suction bell may be provided with a suction pump, which has a filter element at its outlet and laterally to the assembly (on the side where the rotation centre of the apparatus is located). According to a second embodiment, the suction bell is provided with connection means for an outlet from an external suction device.

The device will have lighting means, normally placed in the central body, as well as a camera for transmitting and/or recording images.

The motors which drive the different components of the apparatus are electric and are powered by means of external connection cables. The apparatus could optionally be provided with an electrical power battery to provide the device with greater autonomy, although said option is less preferable through involving other disadvantages, such as the weight of the apparatus, its size and manoeuvrability, and limiting the operation time to the duration of the battery.

### BRIEF DESCRIPTION OF THE DRAWINGS

In order to illustrate the following explanation, we are enclosing . . . pages of drawings with this descriptive report in which six figures represent as an example, without constituting any limitation thereby, one form of embodiment of this invention, and in which:

FIG. 1 shows an exploded view of a dismantled detail of the cleaning apparatus according to the invention;

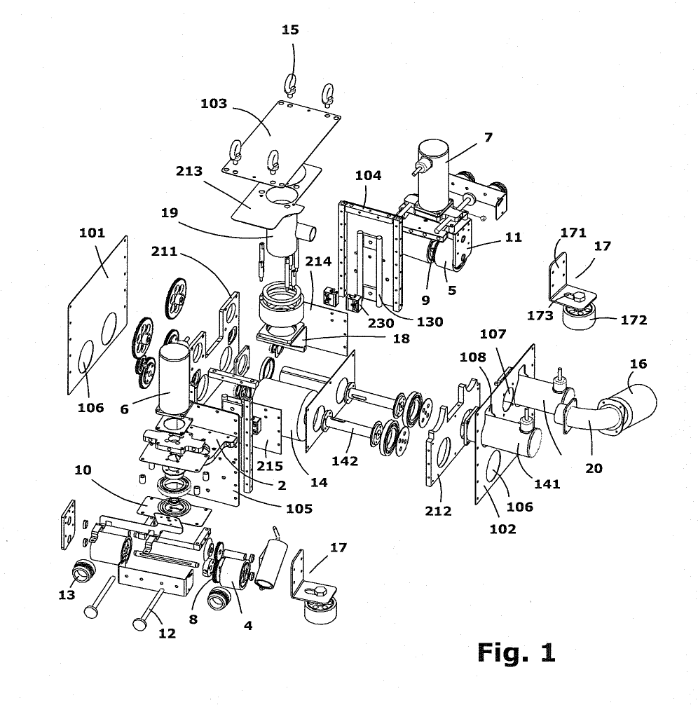

FIG. 2 shows a perspective view of the assembled apparatus of FIG. 1

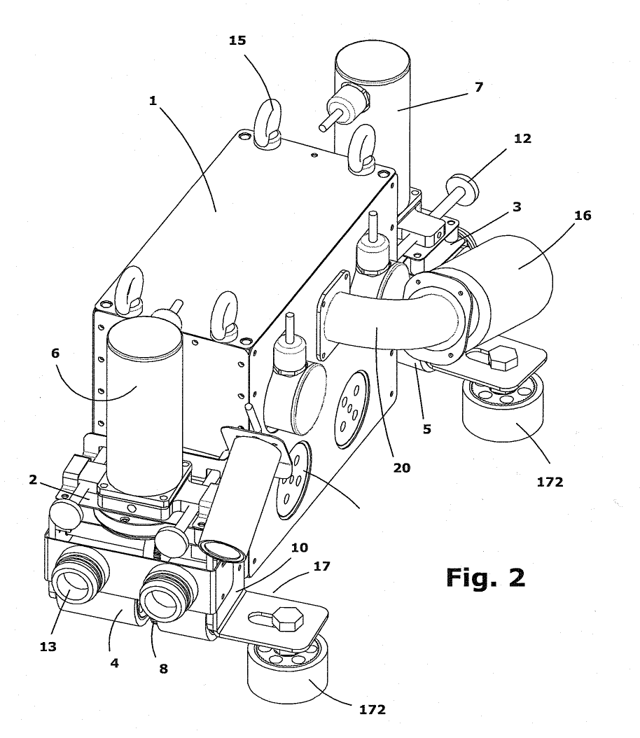

FIG. 3 shows a view from the outer side (the one furthest from the rotation centre) of the apparatus of FIG. 1;

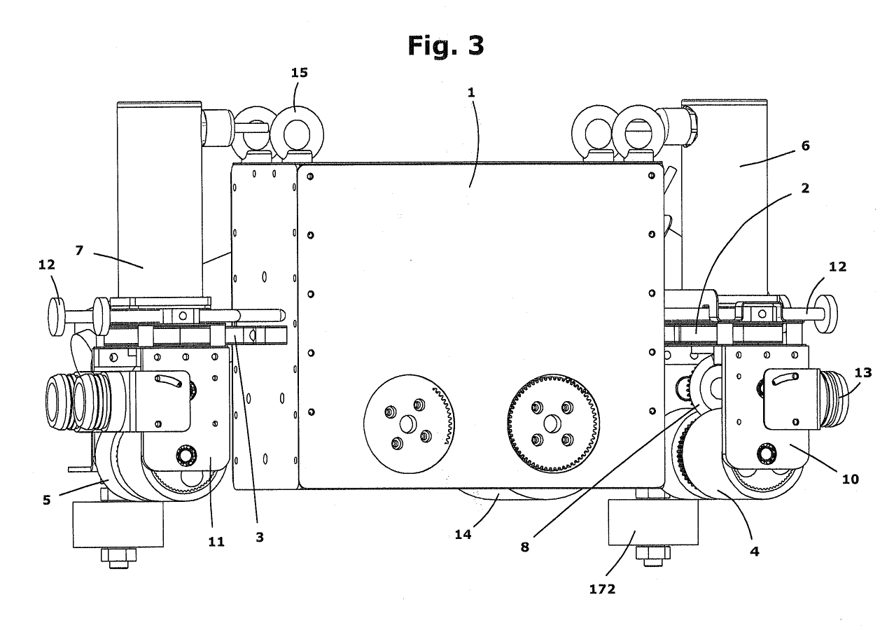

FIG. 4 shows a view from the inner side (the one closest to the rotation centre), of the apparatus of FIGS. 1 and 2;

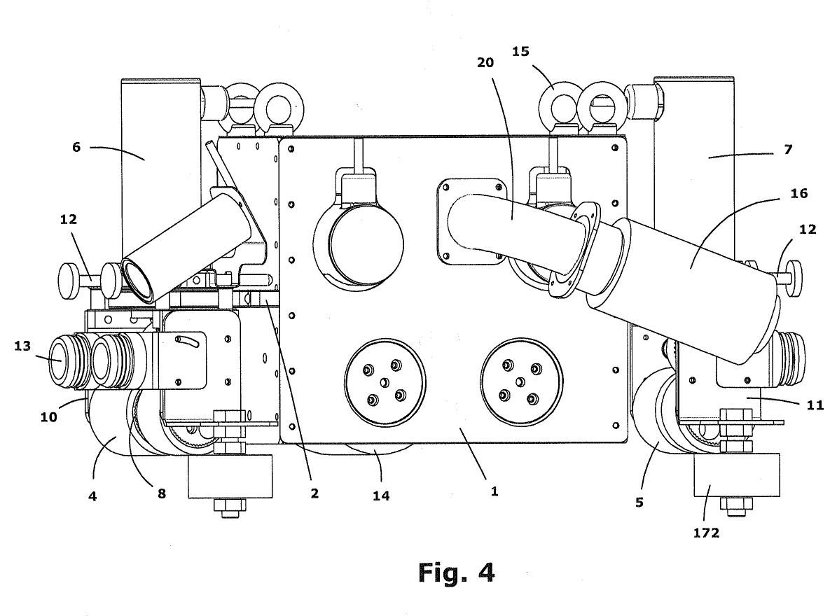

FIG. 5 shows a view from an oblique viewpoint on the horizontal plane in which one can appreciate the front/rear train (according to the movement direction) and corresponding drive rollers or wheels, as well as the mechanism for transmitting the movement from the corresponding motor to said rollers;

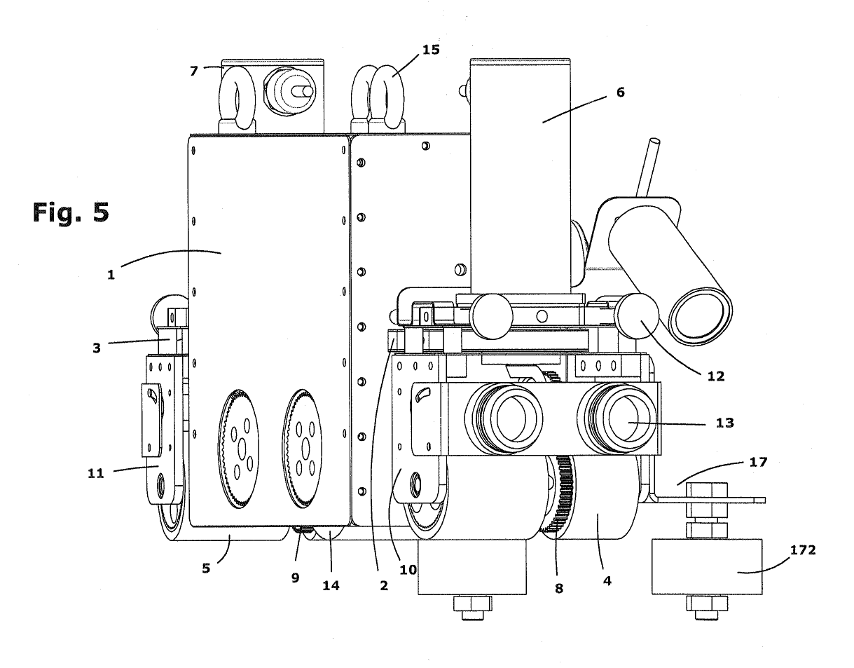

FIG. 6 shows a lower view of the apparatus according to the invention in which one can appreciate the degree of tilt of the front and rear wheels; and

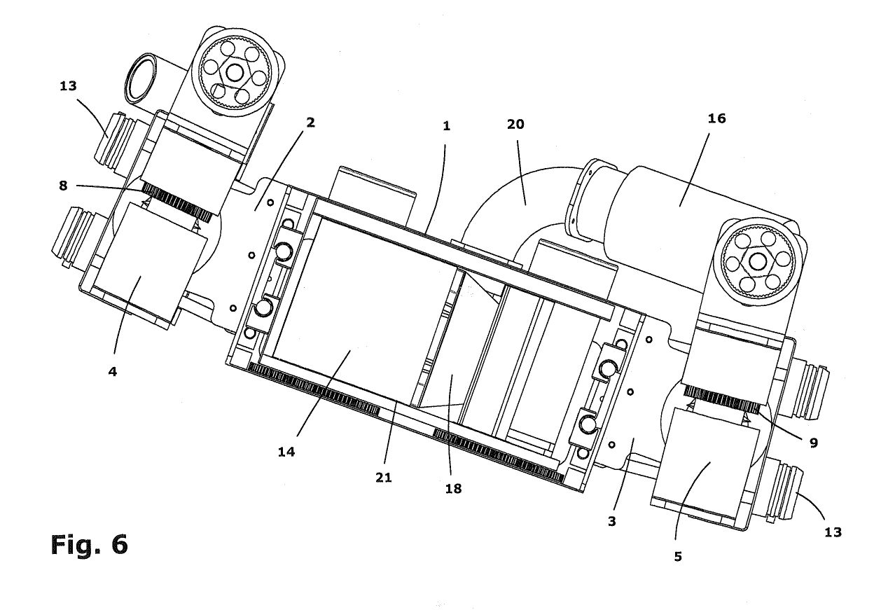

FIG. 7 shows an extended detail of the front train.

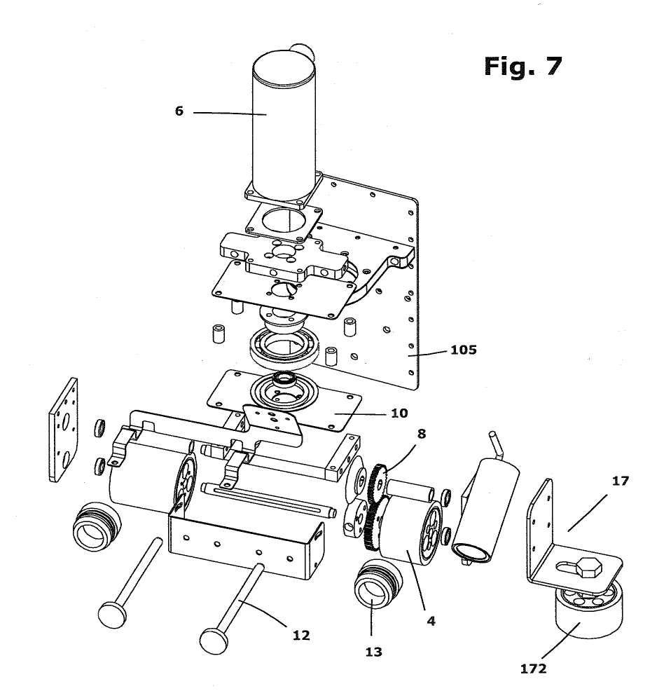

The following reference numbers can be appreciated in these figures:
1 central body
2 front support
3 rear support
4 front drive wheels or rollers
5 rear drive wheels or rollers
6 drive motor for the front rollers
7 drive motor for the rear rollers
8 transmission element for the front rollers
9 transmission element for the rear rollers
10 rotary support for the front rollers
11 rotary support for the rear rollers
12 devices for adjusting the angular position
13 lighting devices
14 cleaning rollers
15 outer anchorages or coupling hitches; lugs
16 particle filter
17 probe assembly
18 suction bell
19 suction pump
20 support for the particle filter
21 floating inner body
101 right-hand lateral plate of the outer casing of the central body (seen from behind looking forward)
102 left-hand lateral plate of the outer casing of the central body (seen from behind looking forward)
103 upper plate of the outer casing of a central body
104 rear plate of the outer casing of the central body
105 front plate of the outer casing of the central body
106 holes in the outer casing for the axles of the cleaning rollers
107 hole in the outer casing for the filter conduit
108 hole in the outer casing of the drive motors for the cleaning rollers
130 guiding devices for the floating body in the outer casing of the central body
141 drive motors for the cleaning rollers
142 axles for the cleaning rollers
171 probe support
172 slot for holding the probe
173 probe wheel or roller
211 right-hand lateral plate of the floating inner body
212 left-hand lateral plate of the floating inner body
213 upper plate of the floating inner body
214 rear plate of the floating inner body
215 front plate of the floating inner body
230 guide devices for the outer casing of the central body in the floating inner body

### DESCRIPTION OF THE PREFERENTIAL FORMS OF EMBODIMENT

An apparatus for cleaning the sealing flange of the vessel of the reactor of a nuclear power plant is described, made up of a central body (1) which houses the cleaning media, and which also comprises front and rear trains made up of respective front (2) and rear (3) supports which hold the front and rear drive media respectively.

The drive media consist of front (4) and (5) drive wheels or rollers respectively, which are driven by respective motors (6,7), through the corresponding transmission elements (8,9).

The front (2) and rear (3) supports are made up of a plate or set of plates forming a bracket or fixed part. The motors (6,7) are placed in a fixed arrangement in said front (2) and rear (3) supports. The front (2) and rear (3) supports hold the front (10) and rear (11) wheel supports. These wheel supports are held in such a way as to be able to turn around a vertical axis, for appropriate positioning and control of the turning radius. The wheel supports (10,11) also have means for adjusting and setting the angular position in respect of the front (2) and rear (3) supports. When the apparatus has to be placed over the flange to proceed to clean this, the annular part of the flange that has to be cleaned will have to be determined, adjusting the inclination of the front and rear wheel supports for their travel to adapt to the item that has to be cleaned. To set the angular position of the wheel supports (10,11) there are devices for adjustment of the angular position (12), and specifically setting screws; more specifically still, it has been designed for said devices for adjusting the angular position to be pairs of setting screws, in which one of these will limit rotation in one direction and the other in the opposite direction. The setting screws are held in a wheel support (10,11) into which these are screwed and whose end can move back or forward, and act against a corresponding stop in the central body (1) or in the front or rear supports (2,3). According to a specific embodiment, the stop consists of one of the walls of the central body (1).

In accordance with a specific embodiment, the drive wheels (4,5) are divided into two portions of different length, and the corresponding transmission bodies (8,9) transmit the movement to the axle of said rollers (4,5) from the connecting zone of these portions (central, if these are identical). This asymmetry means that the drive motors (6,7) can be more satisfactorily located in the ideal position.

The front wheel support (10) and/or the rear wheel support (11) are provided with a probe (17) which regulates the distance of the apparatus to the inner edge of the flange. In a preferential embodiment the probe (17) consists of a wheel or roller (173) rotating on a vertical axis which is held in a support (171). This support is provided with a slot (172) along which the probe wheel (173) can be secured in position, this position determining the greater or lesser distance to the edge of the flange in the cleaning travel. This support may be provided with a graduated scale. As the device moves forward in its cleaning travel, the probe will correct or prevent any outward deviation.

Insofar as the motors (6,7) for powering the drive rollers (4,5) are independent, it has been seen that altering the speed of one of these in respect of the other corrects the trajectory, either getting closer to the edge, when the speed of the front one is greater, or moving away from this when the speed of the rear one is greater.

According to one form of preferential embodiment the central body is made up of two bodies, an outer casing (which is the visible part of the central body) and a floating inner body (21).

The central body (1), and particularly the floating inner body (21) contained in this, holds:
the cleaning media, and particularly a pair of cleaning rollers (14) which move in the opposite rotation direction, moving the dirt from the floor towards the space lying between them;
the drive motors of the cleaning media;
a suction bell (18), whose suction mouth is located in the space lying between the cleaning rollers (14);
a suction pump (19), according to one form of embodiment, or a mouth for a suction conduit, according to another form of embodiment.

The floating inner body (21) is made up of a box open at the bottom, consisting of a front plate (215), a rear plate (214), and lateral plates (211,212), as well as an upper plate (213), provided with attachment media by means of screws and/or tabs. The supports of the cleaning rollers (14) and their drive motors (141) are located between the lateral plates, and normally the upper plate (213) will hold the suction bell and the suction pump (19).

The front (215) and rear (214) plates have, in a particular embodiment, guiding devices (230) in respect of the outer casing.

Hence, the floating inner body (21) is able to move (in a vertical direction) in respect of the outer casing, which enables it to adapt to any small steps, if there were any, and to adjust the relative position in accordance with the wear of the wheels. The force at which the cleaning rollers (14) press on the surface to be cleaned will be that of the weight of the floating inner body (21), although said weight may be adjusted or corrected with additional weight, or reduced with floats or sustaining springs to increase or limit the force which the cleaning rollers (14) exert on the floor to be cleaned. This allows the force of incidence on the floor, and thus the cleaning effectiveness, to be independent of the degree of wear of the brushes. Securing media for the relative position between the floating inner body (21) and the outer casing have nevertheless been designed.

The outer casing is, according to a specific embodiment, made up of lateral plates (101,102) a front plate (105) a rear plate (104) and an upper plate (103), joined together by screws and/or tabs. The outer casing also takes the form of a prismatic box open at the bottom. The front (105) and rear (104) plates are internally provided with different guiding devices (130) complementary to the ones located (230) in the floating inner body (21).

The lateral plates (101,102) are provided with holes (106) giving access to the axles (142) of the cleaning rollers (14) and through which these axles (142) can be dismantled and extracted, and with them the cleaning rollers (14).

Furthermore, at least one of the lateral plates (101,102), and especially the one facing towards the centre of the reactor vessel, is provided with holes (108) through which the drive motors of the cleaning rollers emerge. Since the floating inner body (21) is vertically mobile in respect of the outer casing, these holes (108), must enable the displacement of the motors which are joined to the floating inner body, for which reason these holes (108) substantially have the shape of a vertical slotted hole and are dimensioned so that those motors can move vertically in these from an upper end position of the floating inner body in respect of the outer casing to a lower end position of said floating inner body (21).

Between the outlet of the suction pump (19) located in the floating inner body (21) and the outer casing there is a bellows-type conduit, which will absorb the variations in relative position, and will enable the debris collected to be taken towards a particle filter (16). The particle filter (16) is placed at the end of a support (20) which is fixed and held on the outer casing.

The support is arranged so that the particle filter (16) is located on the side of the central body closest to the centre of the vessel and whose free end is located at a lower height than the end for connection with the support (20) which holds this; this means that there is a lower risk of releasing particles such as radioactive particles outside the filter during dismantling operations.

The apparatus is provided with one or more spotlights, as well as one or more cameras for picking up images, and preferably also means for transmitting images. This enables the situation before and behind the cleaning operation to be observed, determining with greater reliability whether this needs to be gone over again or whether the process can be taken as finished. In accordance with a particular embodiment, the spotlights are located on the front (2) and rear (4) supports, as well as the camera or cameras for taking pictures.

The upper plate of the outer casing of the central body is provided with a set of coupling lugs (15).

Obviously anything to do with the arrangement of the floating inner body over the outer casing can also be embodied in a single central body within the scope of the invention.

What is claimed is:

1. An apparatus for cleaning a sealing flange of a vessel of a reactor of a nuclear power plant, comprising:
a drive for moving the apparatus along a perimeter of the flange;
an arrangement for dislodging any dirt lying on that flange;
a central body, provided with an arrangement for wiping off the dirt, said central body comprising an outer casing which has a front support and a rear support fixed to the outer casing;
a front train holding a front wheel support;
a rear train holding a rear wheel support;
an adjustment device for adjusting an angular position of the front wheel support in respect of the central body; and
an adjustment device for adjusting an angular position of the rear wheel support in respect of the central body.

2. A cleaning apparatus, according to claim 1, wherein:
at least one of the front train and the rear train is made up of a support including at least one plate forming a bracket,
said bracket holds a motor for driving at least one of the front and rear wheel supports which are respectively arranged in vertical position, and
the at least one of the front and rear wheel supports constitutes a moving part which is fitted under the at least one of the front and rear supports respectively and is adapted to rotate in respect of said support.

3. A cleaning apparatus, according to claim 2, wherein each adjustment device includes at least one screw held to the moving part, each of which is placed on one side of a rotation axle of the front support, in which each screw limits rotation of the front support in one rotation direction when the screw rests against a corresponding stop arranged in the fixed part.

4. A cleaning apparatus, according to claim 3, wherein the stop of each screw is one of the front wall and the rear wall, respectively, of the central body.

5. A cleaning apparatus, according to claim 1,
wherein at least one of the front wheel support and rear wheel support hold respective front and rear drive rollers which are divided into two parts, and
further comprising a body for transmitting movement placed between these two parts.

6. A cleaning apparatus, according to claim 5, wherein one of the two parts into which the front and rear drive rollers are divided is of greater width than the other part.

7. A cleaning apparatus, according to claim 1, wherein the central body comprises a floating inner body, said floating inner body holding the arrangement for wiping off the dirt, and said floating body is joined to the outer casing of the central body so as to allow relative vertical displacement therebetween.

8. A cleaning apparatus, according to claim 7, wherein the floating inner body is provided with a guiding device over a casing thereof, and the outer casing is provided with guides for interacting with the guiding device to guide the floating inner body.

9. A cleaning apparatus, according to claim 8, wherein the guiding device between the floating inner body and the outer casing is provided with an arrangement for securing the floating inner body in a desired relative position.

10. A cleaning apparatus, according to claim 7, wherein a connection between the floating body and the outer casing is provided with an arrangement for adjusting tension between the floating body and the outer casing.

11. A cleaning apparatus, according to claim 1, wherein the arrangement for wiping off the dirt includes a pair of front and rear cleaning rollers driven by respective motors, with mutually inverse movement, so that both rollers wipe the dirt off a floor towards a space between the rollers.

12. A cleaning apparatus, according to claim 1, wherein the outer casing of the central body is formed of lateral plates, a front plate, a rear plate and an upper plate, joined together by one of screws and tabs.

13. A cleaning apparatus, according to claim 7, wherein lateral plates forming the outer casing of the central body are provided with holes through which drive motors of cleaning rollers emerge, said holes substantially each having the form of a vertical slotted hole and are dimensioned in such a way that said drive motors can move vertically from an upper end position of the floating inner body in respect of the outer casing to a lower end position of said floating inner body.

14. A cleaning apparatus, according to claim 7, wherein the floating inner body also comprises a suction bell having an absorption inlet located between a pair of cleaning rollers.

15. A cleaning apparatus, according to claim 14, wherein the floating inner body also comprises a suction pump connected to the suction bell.

16. A cleaning apparatus, according to claim 15, wherein at least one lateral plate forming the outer casing of the central body is provided with a support for a particle filter, and the support for the particle filter is connected to the suction pump by a bellows-type conduit.

17. A cleaning apparatus, according to claim 16, further comprising a particle filter, which is located on a side of the central body closest to a center of the vessel, and having a free end located at a lower height than an end for joining to a corresponding support.

18. A cleaning apparatus, according to claim 14, wherein the suction bell is provided with a connection for an external suction inlet.

19. A cleaning apparatus, according to claim 11, wherein lateral plates forming the outer casing of the central body are provided with holes for access to roller axles, and the cleaning rollers are provided with the roller axles removable from at least one of the lateral plates, through said holes.

20. A cleaning apparatus, according to claim 1, wherein at least one of the front and rear wheel supports is provided with a probe which adjusts the distance from the central body to an inner edge of the sealing flange.

21. A cleaning apparatus, according to claim 20, wherein the probe includes a wheel held on a vertical axis and placed on a slotted support and adapted to be adjusted in different positions along said slotted support.

22. A cleaning apparatus, according to claim 21, the slotted support is provided with a graduated scale.

23. A cleaning apparatus, according to claim 1, wherein the central body is provided with spotlights for lighting.

24. A cleaning apparatus, according to claim 1, wherein the central body is provided with at least one camera for taking pictures.

25. A cleaning apparatus, according to claim 1, wherein an upper plate of the outer casing of the central body is provided with a set of coupling lugs.
